(19) United States
(12) Patent Application Publication
(10) Pub. No.: US 2026/0246046 A1
(43) Pub. Date: Aug. 20, 2026

(54) BATTERY PACK

(71) Applicant: Makita Corporation, Anjo-shi (JP)

(72) Inventor: Junichi MURAKAMI, Anjo-shi (JP)

(73) Assignee: Makita Corporation, Anjo-shi (JP)

(21) Appl. No.: 19/537,682

(22) Filed: Feb. 12, 2026

(30) Foreign Application Priority Data
Feb. 17, 2025 (JP) 2025-023281

(51) Int. Cl. H01M 50/213

(52) U.S. Cl. CPC H01M 50/213

(57) ABSTRACT

A battery pack may be configured to be detachably attached to a battery pack attaching part by the battery pack sliding relative to the battery pack attaching part. The battery pack may include: a casing; and a plurality of battery cells accommodated inside the casing. A through hole which opens downward may be defined in the casing. In a front-rear direction, the through hole may be disposed rearward of a front end of a frontmost battery cell among the plurality of battery cells and frontward of a rear end of a rearmost battery cell among the plurality of battery cells. In an up-down direction, an inner surface of the casing at a portion where the through hole is defined may be disposed above a lower end of a lowermost battery cell among the plurality of battery cells.

### CROSS REFERENCE TO RELATED APPLICATION(S)

This application claims priority from Japanese Patent Application No. 2025-023281, filed on February 17, 2025. The entire content of the priority application is incorporated herein by reference.

### TECHNICAL FIELD

The art disclosed herein relates to a battery pack.

### BACKGROUND ART

Japanese Patent Application Publication No. 2022-140486 describes a battery pack configured to be detachably attached to a battery pack attaching part by sliding relative to the battery pack attaching part. The battery pack may include: a casing; and a plurality of battery cells accommodated inside the casing. A front direction is defined as a direction of sliding the battery pack when detaching the battery pack from the battery pack attaching part, a rear direction is defined as a direction of sliding the battery pack when attaching the battery pack to the battery pack attaching part, an up direction is defined as a direction in which the battery pack attaching part is positioned as viewed from the battery pack when the battery pack is attached to the battery pack attaching part, a down direction is defined as a direction opposite the up direction, a left-right direction is defined as a direction perpendicular to a front-rear direction and an up-down direction. A through hole which opens rearward is defined in the casing. In the front-rear direction, the through hole is disposed rearward of a rear end of a rearmost battery cell among the plurality of battery cells. In the up-down direction, an inner surface of the casing at a portion where the through hole is defined is disposed above a lower end of a lowermost battery cell among the plurality of battery cells.

### SUMMARY

When this battery pack is charged using a charger, a fan incorporated in the charger may be driven to draw air out from within the casing toward the charger so as to cool the plurality of battery cells. In doing so, the air flows into the casing from outside through the through hole defined in the casing. The air flowing into the casing cools the plurality of battery cells and then flows out to the charger. In the battery pack of Japanese Patent Application Publication No. 2022-140486, since the through hole is defined in the rear surface of the casing, although the air flows from the rear surface of the casing, heat tends to be accumulated near the lower surface of the casing since there is no air flowing in from the lower surface of the casing. As a result of this, the battery cell(s) near the lower surface of the casing may remain excessively hot. The present teachings provide an art configured to suppress a battery cell near a lower surface of a casing from becoming excessively hot.

A battery pack disclosed herein may be configured to be detachably attached to a battery pack attaching part by sliding relative to the battery pack attaching part. The battery pack may comprise: a casing; and a plurality of battery cells accommodated inside the casing. A front direction may be defined as a direction of sliding the battery pack when detaching the battery pack from the battery pack attaching part. A rear direction may be defined as a direction of sliding the battery pack when attaching the battery pack to the battery pack attaching part. An up direction may be defined as a direction in which the battery pack attaching part is positioned as viewed from the battery pack when the battery pack is attached to the battery pack attaching part. A down direction may be defined as a direction opposite the up direction. A left-right direction may be defined as a direction perpendicular to a front-rear direction and an up-down direction. A through hole which opens downward may be defined in the casing. In the front-rear direction, the through hole may be disposed rearward of a front end of a frontmost battery cell among the plurality of battery cells and frontward of a rear end of a rearmost battery cell among the plurality of battery cells. In the up-down direction, an inner surface of the casing at a portion where the through hole is defined may be disposed above a lower end of a lowermost battery cell among the plurality of battery cells.

According to the above configuration, when the fan incorporated in the charger is driven such that air is drawn out from within the casing toward the charger, the air flows in through the through hole that is disposed rearward of the front end of the frontmost battery cell and frontward of the rear end of the rearmost battery cell and also opened downward, as a result of which accumulation of heat near the lower surface of the casing can be suppressed. This configuration can suppress the battery cell(s) near the lower surface of the casing from becoming excessively hot. Further, in the above configuration, the inner surface of the casing at the position where the through hole is defined is above the lower surface of the lowermost battery cell. Due to this, when the battery pack is placed on the resting surface such that the lower surface of the casing contacts the resting surface, it is possible to more effectively suppress water and/or mud on the resting surface from adhering to the through hole and thereby blocking the through hole.

### BRIEF DESCRIPTION OF DRAWINGS

FIG. 1 illustrates a perspective view seeing a battery pack 2 according to a first embodiment from a rear right upper side.

FIG. 2 illustrates a perspective view seeing the battery pack 2 according to the first embodiment from a rear left lower side in a state of being attached to a charger 4.

FIG. 3 illustrates a cross-sectional view seeing the battery pack 2 according to the first embodiment from the right side.

FIG. 4 illustrates a perspective view seeing the battery pack 2 according to the first embodiment from a front right lower side.

FIG. 5 illustrates a bottom view of the battery pack 2 according to the first embodiment.

FIG. 6 illustrates an enlarged cross-sectional view of a first air holes 48 and its surroundings in the battery pack 2 according to the first embodiment from the right side.

FIG. 7 illustrates an enlarged cross-sectional view seeing a second air hole 50 and its surroundings in the battery pack 2 according to the first embodiment from the right side.

FIG. 8 illustrates a perspective view seeing a battery pack 102 according to the second embodiment from the rear right upper side.

FIG. 9 illustrates a perspective view seeing the battery pack 102 according to the second embodiment from the rear left lower side in a state of being attached to the charger 4.

FIG. 10 illustrates a cross-sectional view seeing the battery pack 102 according to the second embodiment from the right side.

FIG. 11 illustrates a perspective view seeing the battery pack 102 according to the second embodiment from the front right lower side.

FIG. 12 illustrates a bottom view of the battery pack 102 according to the second embodiment.

FIG. 13 illustrates an enlarged cross-sectional view seeing a first air hole 148, a second air hole 150, and their surroundings in the battery pack 102 according to the second embodiment from the right side.

### DETAILED DESCRIPTION

Representative, non-limiting examples of the present disclosure will now be described in further detail with reference to the attached drawings. This detailed description is merely intended to teach a person of skill in the art further details for practicing preferred aspects of the present teachings and is not intended to limit the scope of the present disclosure. Furthermore, each of the additional features and teachings disclosed below may be utilized separately or in conjunction with other features and teachings to provide improved battery packs, as well as methods for using and manufacturing the same.

Moreover, combinations of features and steps disclosed in the following detailed description may not be necessary to practice the present disclosure in the broadest sense, and are instead taught merely to particularly describe representative examples of the present disclosure. Furthermore, various features of the above-described and below-described representative examples, as well as the various independent and dependent claims, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

In a first aspect disclosed herein, a battery pack may be configured to be detachably attached to a battery pack attaching part by sliding relative to the battery pack attaching part. The battery pack may comprise: a casing; and a plurality of battery cells accommodated inside the casing. A front direction may be defined as a direction of sliding the battery pack when detaching the battery pack from the battery pack attaching part. A rear direction may be defined as a direction of sliding the battery pack when attaching the battery pack to the battery pack attaching part. An up direction may be defined as a direction in which the battery pack attaching part is positioned as viewed from the battery pack when the battery pack is attached to the battery pack attaching part. A down direction may be defined as a direction opposite the up direction. A left-right direction may be defined as a direction perpendicular to a front-rear direction and an up-down direction. A through hole which opens downward may be defined in the casing. In the front-rear direction, the through hole may be disposed rearward of a front end of a frontmost battery cell among the plurality of battery cells and frontward of a rear end of a rearmost battery cell among the plurality of battery cells. In the up-down direction, an inner surface of the casing at a portion where the through hole is defined may be disposed above a lower end of a lowermost battery cell among the plurality of battery cells.

In a second aspect disclosed herein, in the above-mentioned first aspect, the plurality of battery cells may comprise: a first battery cell having a longitudinal direction extending in the left-right direction; and a second battery cell having a longitudinal direction extending in the left-right direction and disposed adjacent to and rearward of the first battery cell. In the front-rear direction, the through hole may be disposed rearward of a center of the first battery cell and frontward of a center of the second battery cell.

According to the above configuration, the first battery cell and the second battery cell that are adjacent to each other in the front-rear direction can be cooled in a well-balanced manner.

In a third aspect disclosed herein, in the above-mentioned second aspect, the through hole may have an elongated hole shape having a longitudinal direction extending in the left-right direction.

According to the above configuration, the first battery cell and the second battery cell can be more uniformly cooled in the left-right direction.

In a fourth aspect disclosed herein, in the above-mentioned first or second aspect, a recess may be defined in a lower surface of the casing. The recess may be recessed upward and extend in the left-right direction. The through hole may be disposed in the recess.

According to the above configuration, the through hole can be provided in the casing by utilizing the recess that was formed for the purpose of a finger rest for a user to grasp the battery pack.

In a fifth aspect disclosed herein, in the above-mentioned fourth aspect, the through hole may have an elongated hole shape having a longitudinal direction extending in the left-right direction.

According to the above configuration, when the user utilizes the recess as a finger groove for grasping the battery pack, the through hole can function as a non-slip feature for the finger.

In a sixth aspect disclosed herein, in one of the above-mentioned first to fifth aspects, when the battery pack is placed on a resting surface such that a lower surface of the casing contacts the resting surface, the through hole may communicate with a space positioned frontward, rearward, leftward, or rightward of the battery pack.

According to the above configuration, when the plurality of battery cells is in a high-temperature state and the battery pack is placed on the resting surface such that the lower surface of the casing contacts the resting surface, air can flow from the outside into the casing through the through hole due to chimney effect, by which the plurality of battery cells can be cooled.

In a seventh aspect disclosed herein, in one of the above-mentioned first to sixth aspects, in the up-down direction, the inner surface of the casing at the portion where the through hole is defined may be disposed above a center of the lowermost battery cell among the plurality of battery cells.

According to the above configuration, when the battery pack is placed on the resting surface such that the lower surface of the casing contacts the resting surface, it is possible to more effectively suppress water and/or mud on the resting surface from adhering to the through hole and thereby blocking the through hole.

### First Embodiment

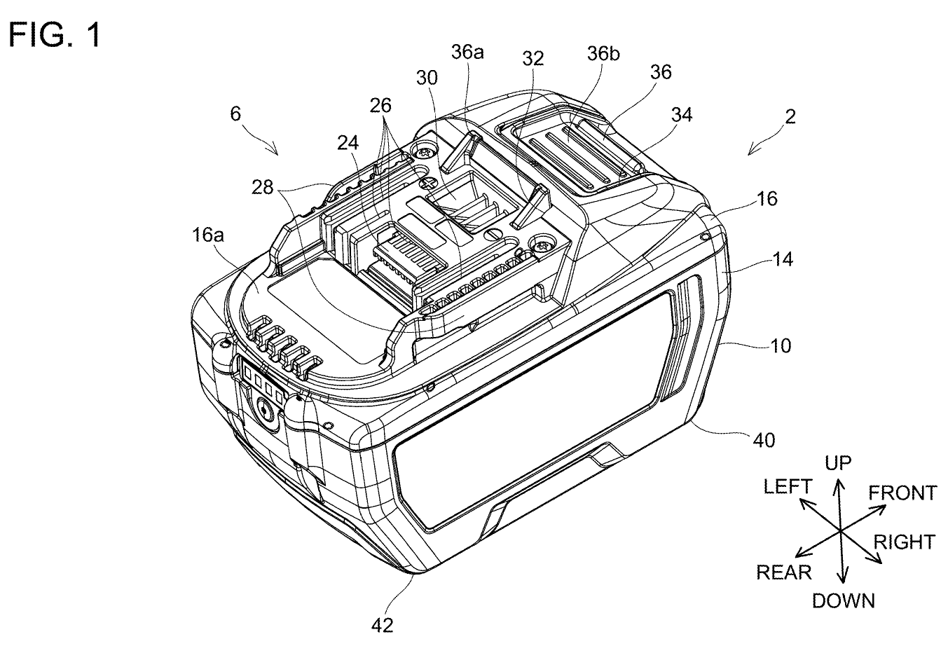

A battery pack 2 of the present embodiment shown in FIG. 1 is configured to be detachably attached to electrical equipment (not shown). The electrical equipment operates on electric power supplied from the battery pack 2. The electrical equipment may be a motor-driven power tool such as a driver or a drill, or may be a motor-driven power working machine such as a grass cutter or a blower. Alternatively, the electrical equipment may be equipment that does not have a motor, such as a light, radio, or a loudspeaker. The rated voltage of the battery pack 2 is for example 18V. The maximum voltage of the battery pack 2 is for example 20V. The rated capacity of the battery pack 2 is for example 9.0Ah.

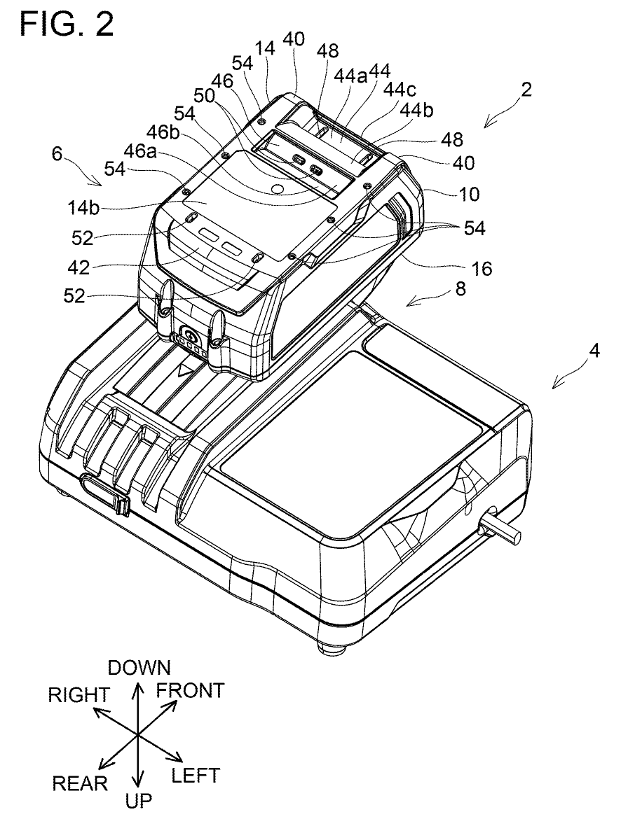

As illustrated in FIG. 2, the battery pack 2 is configured to be detachably attached to a charger 4. The battery pack 2 is configured to be charged with electric power supplied from the charger 4. The battery pack 2 comprises an equipment attaching part 6. The charger 4 comprises a battery pack attaching part 8. The battery pack 2 is configured to be attached to the charger 4 by sliding the equipment attaching part 6 relative to the battery pack attaching part 8. Hereafter, a direction of sliding the battery pack 2 when the battery pack 2 is to be attached to the battery pack attaching part 8 will be termed a rear direction, whereas a direction of sliding the battery pack 2 when the battery pack 2 is to be detached from the battery pack attaching part 8 will be termed a front direction. Likewise, a direction in which the battery pack attaching part 8 is positioned when viewed from the battery pack 2 when the battery pack 2 is attached to the battery pack attaching part 8 will be termed an up direction whereas a direction opposite from the up direction will be termed a down direction. Further, a direction perpendicular to the front-rear direction and the up-down direction will be termed a left-right direction.

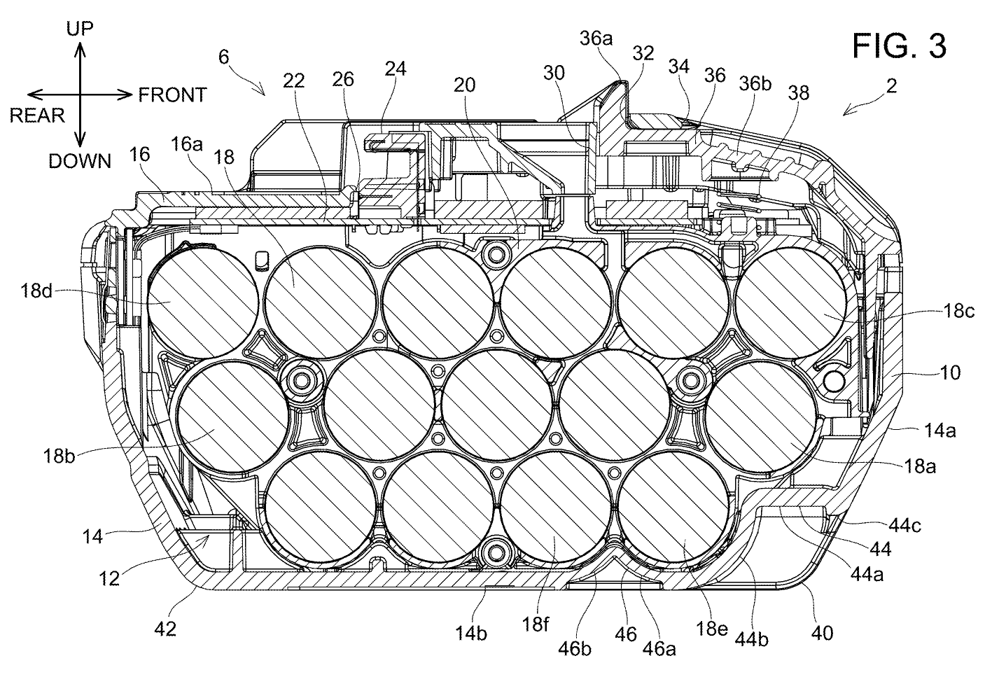

As illustrated in FIG. 3, the battery pack 2 comprises a casing 10 and a battery cell unit 12 accommodated in the casing 10. The casing 10 comprises a lower casing 14 and an upper casing 16. The dimension of the battery pack 2 in the up-down direction is within the range of 60mm-100mm for example, and more specifically, is 79mm, for example. The dimension of the battery pack 2 in the front-rear direction is within the range of 115mm-155mm for example, and is more specifically, 136mm for example. The dimension of the battery pack 2 in the left-right direction is within the range of 55mm-95mm for example, and is more specifically 76mm, for example. The weight of the battery pack 2 is within the range of 0.6kg to 1.4kg for example, and may more specifically be 1kg, for example.

The battery cell unit 12 comprises a plurality of battery cells 18, a cell holder 20 configured to hold the plurality of battery cells 18, and a control circuit board 22 disposed above the cell holder 20 and held by the cell holder 20. A battery-side terminal 24 is disposed on the upper surface of the control circuit board 22.

The plurality of battery cells 18 is arranged in three tiers in the up-down direction. Each battery cell 18 is for example a lithium-ion battery cell. Alternatively, each battery cell 18 may be another type of secondary battery cell. Each battery cell 18 has a substantially cylindrical shape, and is arranged with its longitudinal direction aligned along the left-right direction. The shape of each battery cell 18 is for example is a 18650 type, and has a 18mm diameter and a longitudinal directional dimension of 65mm. Alternatively, the shape of each battery cell 18 is for example a 21700 type, and may have a 21mm diameter and a longitudinal directional dimension of 70mm. In the first tier from the bottom, four battery cells 18 are arranged side-by-side in the front-rear direction. The battery cells 18 in the first tier from the bottom are arranged such that the positions thereof in the up-down direction are substantially the same as each other. The battery cells 18 in the first tier from the bottom are all located lowermost among the plurality of battery cells 18. In the second tier from the bottom, five battery cells 18 are arranged side-by-side in the front-rear direction. In the front-rear direction, the position of the center of each battery cell 18 in the second tier from the bottom is arranged so as not to overlap the position of the center of each battery cell 18 in the first tier from the bottom. Among the battery cells 18 in the second tier from the bottom, a battery cell 18a which is the first frontmost cell (first cell on the front side) and a battery cell 18b which is the first rearmost cell (first cell on the rear side) are disposed slightly lower than the other battery cells 18. In the third tier from the bottom, that is, the first tier from the top, six battery cells 18 are arranged side-by-side in the front-rear direction. In the front-rear direction, the position of the center of each battery cell 18 in the third tier from the bottom is arranged so as not to overlap the position of the center of each battery cell 18 in the second tier from the bottom. The battery cells 18 from the third tier from the bottom are arranged such that the positions thereof in the up-down direction are all substantially the same as each other. Among the battery cells 18 in the third tier from the bottom, a battery cell 18c which is the first frontmost cell is located frontmost among the plurality of battery cells 18, and a battery cell 18d which is the first rearmost cell is located rearmost among the plurality of battery cells 18.

As illustrated in FIG. 1, an upper surface 16a of the upper casing 16 comprises a terminal opening (opening for terminal) 26, battery-side rails 28, a cooling opening 30, an engaging opening 32, and an operation opening 34. The terminal opening 26 is arranged at a position corresponding to the battery-side terminal 24 of the control circuit board 22. When attaching the battery pack 2 to an electrical equipment or the charger 4, the battery-side terminal 24 of the battery pack 2 and the equipment-side terminal (not shown) of the electrical equipment or the charger 4 mechanically engage and electrically connect with each other via the terminal opening 26. The battery-side rails 28 extend in the front-rear direction to the left and right of the terminal opening 26. When attaching the battery pack 2 to the electrical equipment or the charger 4, the battery-side rails 28 of the battery pack 2 slidably engage with equipment-side rails (not shown) of the electrical equipment or the charger 4 in the front-rear direction. The cooling opening 30 is positioned frontward of the terminal opening 26. When the battery pack 2 is attached to the charger 4 for charging, cooling air flows into the casing 10 through the cooling opening 30 due to a built-in fan (not shown) of the charger 4 being driven. Alternatively, when the battery pack 2 is attached to the charger 4 for charging, cooling air may flow out from within the casing 10 through the cooling opening 30 due to the built-in fan of the charger 4 being driven. The engaging opening 32 is positioned frontward of the cooling opening 30. The operation opening 34 is positioned frontward of the engaging opening 32. A hook 36 is attached to both the engaging opening 32 and the operation opening 34. The hook 36 includes an engagement portion 36a protruding outward from the engaging opening 32 and an operation portion 36b exposed outward through the operation opening 34. As illustrated in FIG. 3, the hook 36 is supported on the cell holder 20 via a compression spring 38. The compression spring 38 biases the hook 36 upward relative to the cell holder 20.

In the state where the battery pack 2 is attached to the electrical equipment or the charger 4, the engagement portion 36a engages with an engagement groove (not shown) of the electrical equipment or the charger 4, by which the battery pack 2 is prohibited from sliding frontward. This prevents the battery pack 2 from being detached from the electrical equipment or the charger 4. When detaching the battery pack 2 from the electrical equipment or the charger 4, a user performs a push operation on the operation portion 36b. This operation moves the hook 36 downward, disengaging the engagement portion 36a from the engagement groove of the electrical equipment or the charger 4, allowing the battery pack 2 to slide frontward relative to the electrical equipment or the charger 4. By sliding the battery pack 2 frontward from this state, the user can detach the battery pack 2 from the electrical equipment or the charger 4.

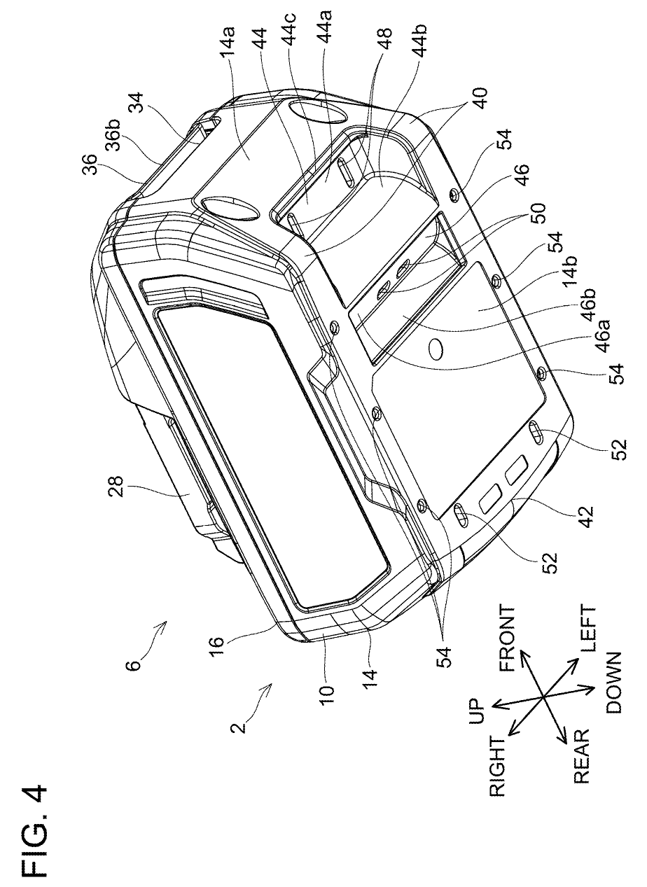

As illustrated in FIG. 4, front guard portions 40 protruding frontward and downward are arranged at a front lower right end and a front lower left end of the lower casing 14. A rear guard portion 42 protruding rearward and downward is arranged at a rear lower end of the lower casing 14. If the battery pack 2 accidentally falls, the front guard portions 40 and/or rear guard portion 42 will collide with the ground or floor surface. As illustrated in FIG. 3, within the casing 10, each battery cell 18 is positioned away from the front guard portions 40 and rear guard portion 42. Therefore, even if the front guard portions 40 and/or rear guard portion 42 collide with the ground or floor surface, damage to each battery cell 18 can be suppressed.

As illustrated in FIG. 4, the lower casing 14 comprises a first finger rest recess 44 and a second finger rest recess 46. The first finger rest recess 44 is positioned inward of the front guard portions 40 in the left-right direction, extending across a front surface 14a and a lower surface 14b of the lower casing 14. The front-rear directional dimension of the first finger rest recess 44 is, for example, within the range of 10 mm to 50 mm, and more specifically, for example, 27 mm. The left-right directional dimension of the first finger rest recess 44 is, for example, within the range of 40 mm to 80 mm, and more specifically, for example, 48 mm. The second finger rest recess 46 is positioned rearward of the first finger rest recess 44 on the lower surface 14b of the lower casing 14. The front-rear directional dimension of the second finger rest recess 46 is, for example, within the range of 5 mm to 30 mm, and more specifically, for example, 16 mm. The left-right directional dimension of the second finger rest recess 46 is, for example, within the range of 40 mm to 80 mm, and more specifically, for example, 48 mm. The left-right directional width of the first finger rest recess 44 and the left-right directional width of the second finger rest recess 46 are substantially the same.

As illustrated in FIG. 3, the first finger rest recess 44 is positioned close to both the battery cell 18e which is the first frontmost cell among the battery cells 18 in the first tier from the bottom and the battery cell 18a which is the first frontmost cell among the battery cells 18 in the second tier from the bottom. The first finger rest recess 44 comprises a substantially flat finger rest surface 44a disposed along the front-rear and left-right directions and facing downward, a cylindrical surface 44b having a substantially cylindrical shape, which is disposed rearward and downward relative to the finger rest surface 44a and conforms to the outer shape of the front lower portion of the battery cell 18e; and a slip-resistant portion 44c protruding downward from the front end of the finger rest surface 44a and extending in the left-right direction. The up-down directional distance from the lower surface 14b of the lower casing 14 to the finger rest surface 44a is, for example, within the range of 5 mm to 25 mm, and more specifically, for example, 14 mm. The front-rear directional dimension of the finger rest surface 44a is, for example, within the range of 2 mm to 15 mm, and more specifically, for example, 10 mm. In the up-down direction, the finger rest surface 44a is positioned above the lower end of the battery cell 18e, above the center of the battery cell 18e, below the upper end of the battery cell 18e, and below the lower end of the battery cell 18a. In the front-rear direction, the rear end of the finger rest surface 44a is positioned rearward of the front end of the battery cell 18a, rearward of the center of the battery cell 18a, frontward of the rear end of the battery cell 18a, and frontward of the front end of the battery cell 18e. That is, the first finger rest recess 44 is positioned in front of battery cell 18e and is arranged in a space below battery cell 18a. In the front-rear direction, the front end of the finger rest surface 44a is positioned frontward of the front end of the battery cell 18a, frontward of the center of the battery cell 18c which is the first frontmost cell among the battery cells 18 in the third tier from the bottom, and rearward of the front end of the battery cell 18c.

The second finger rest recess 46 is positioned close to the battery cell 18e which is the first frontmost cell and the battery cell 18f which is the second frontmost cell among the battery cells 18 in the first tier from the bottom. The second finger rest recess 46 comprises a front cylindrical surface 46a having a substantially cylindrical surface shape conforming to the outer shape of the rear lower portion of the battery cell 18e, and a rear cylindrical surface 46b having a substantially cylindrical surface shape conforming to the outer shape of the front lower portion of the battery cell 18f.

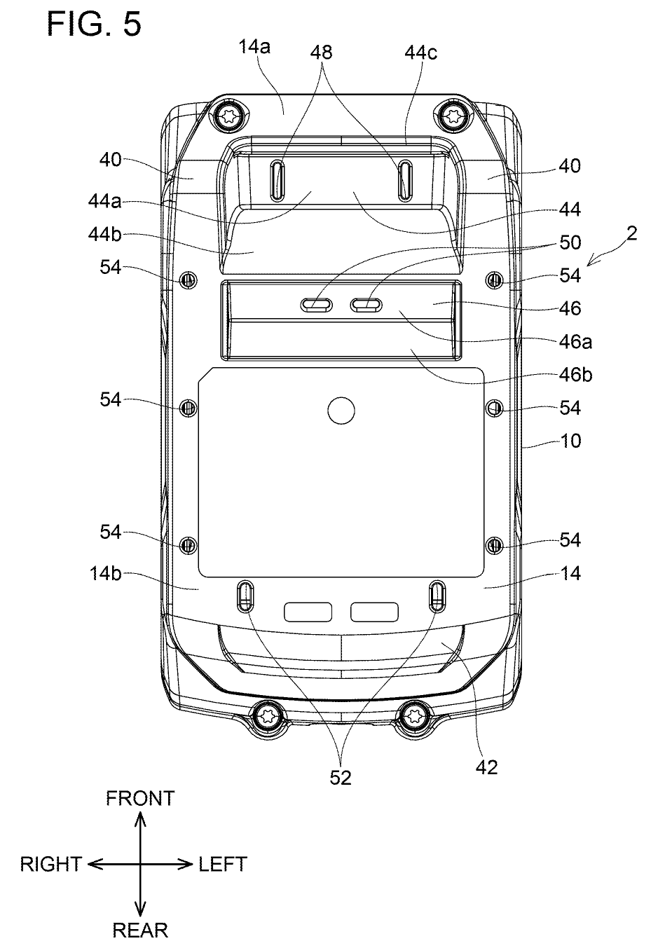

As illustrated in FIG. 5, the lower casing 14 comprises two first air holes 48, two second air holes 50, two third air holes 52, and six drain holes 54. The first air holes 48 have an elongated hole shape with a longitudinal direction extending in the front-rear direction and are arranged side-by-side in the left-right direction on the finger rest surface 44a of the first finger rest recess 44. The front-rear directional dimension of each first air holes 48 is, for example, within the range of 1 mm to 15 mm, and more specifically, for example, 8 mm. The left-right directional width of each first air holes 48 is, for example, within the range of 1 mm to 4 mm, and more specifically, for example, 3 mm. The second air holes 50 have an elongated hole shape with a longitudinal direction extending in the left-right direction and are arranged side-by-side in the left-right direction on the front cylindrical surface 46a of the second finger rest recess 46. The front-rear directional dimension of each second air hole 50 is, for example, within the range of 1 mm to 4 mm, and more specifically, for example, 1.5 mm. The left-right directional dimension of each second air hole 50 is, for example, within the range of 1 mm to 10 mm, and more specifically, for example, 5.5 mm. The third air holes 52 have an elongated hole shape with a longitudinal direction extending in the front-rear direction and are arranged side-by-side in the left-right direction near the rear end of the lower surface 14b of the lower casing 14. The front-rear directional dimension of each third air hole 52 is, for example, within the range of 1 mm to 10 mm, and more specifically, for example, 7 mm. The left-right directional dimension of each third air hole 52 is, for example, within the range of 1 mm to 4 mm, and more specifically, for example, 3.5 mm. The drain holes 54 have a circular hole shape and are arranged side-by-side in the front-rear direction near the right end and left end of the lower surface 14b of the lower casing 14. The diameter of each drain hole 54 is, for example, within the range of 1 mm to 4 mm, and more specifically, for example, 2.5 mm. In the left-right direction, the third air holes 52 are positioned inward of the drain holes 54, the first air holes 48 are positioned inward of the third air holes 52, and the second air holes 50 are positioned inward of the first air holes 48.

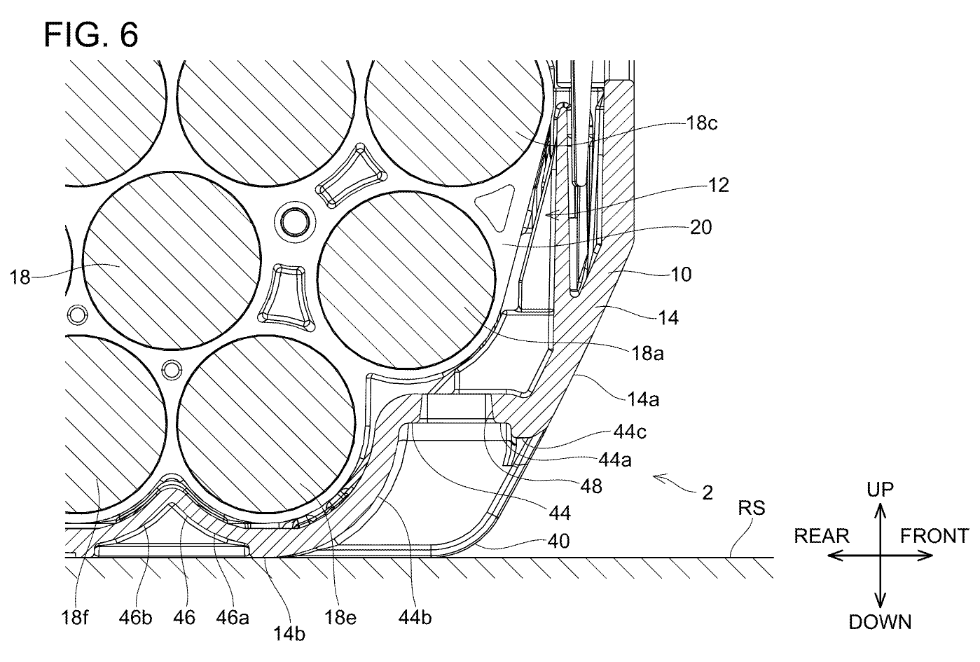

As illustrated in FIG. 6, in the up-down direction, the inner surface of the lower casing 14 at the location where the first air holes 48 are positioned (i.e., the finger rest surface 44a) is positioned above the lower end of the battery cell 18e, positioned above the center of the battery cell 18e, positioned below the upper end of the battery cell 18e, and positioned below the lower end of the battery cell 18a. In the front-rear direction, the front ends of the first air holes 48 are positioned rearward of the front end of the battery cell 18c, which is located frontmost among the plurality of battery cells 18, frontward of the center of the battery cell 18c, and frontward of the rear end of the battery cell 18c. In the front-rear direction, the rear ends of the first air holes 48 are positioned rearward of the front end of the battery cell 18c, which is located frontmost among the plurality of battery cells 18, rearward of the center of the battery cell 18c, and frontward of the rear end of the battery cell 18c. When the battery pack 2 is placed on the resting surface RS such that the lower surface 14b of the lower casing 14 contacts the resting surface RS, the first air holes 48 communicate with a space positioned frontward of the battery pack 2.

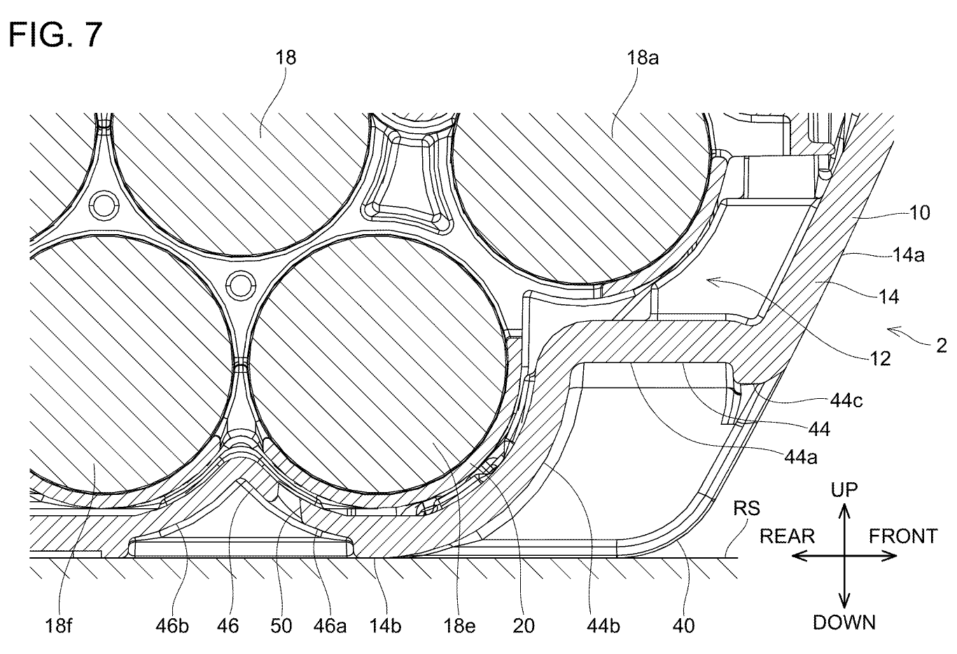

As illustrated in FIG. 7, in the up-down direction, the inner surface of the lower casing 14 at the location where the second air holes 50 are positioned (namely, the front cylindrical surface 46a) is positioned above the lower end of the battery cell 18e, positioned above the lower end of the battery cell 18f, positioned below the center of the battery cell 18e, and positioned below the center of the battery cell 18f. In the front-rear direction, the front ends of the second air holes 50 are positioned rearward of the center of the battery cell 18e and positioned frontward of the rear end of the battery cell 18e. In the front-rear direction, the rear ends of the second air holes 50 are positioned rearward of the center of the battery cell 18e and frontward of the rear end of the battery cell 18e. When the battery pack 2 is placed on the resting surface RS such that the lower surface 14b of the lower casing 14 contacts the resting surface RS, the second air holes 50 do not communicate with spaces positioned frontward, rearward, leftward, or rightward of the battery pack 2.

As illustrated in FIG. 5, the third air holes 52 and the drain holes 54 are both defined in the lower surface 14b of the lower casing 14, and are therefore positioned below the first air holes 48 and the second air holes 50. Therefore, if water enters the interior of the casing 10, positioning the battery pack 2 such that the lower surface 14b of the lower casing 14 faces vertically downward allows the water inside the casing 10 to be discharged outside of the casing 10 through the third air holes 52 and the drain holes 54.

As illustrated in FIG. 2, a case where air flows into the casing 10 through the cooling opening 30 by operation of a built-in fan of the charger 4 when the battery pack 2 is attached to the charger 4 for charging will be considered. In this case, the air flowing into the casing 10 through the cooling opening 30 cools the plurality of battery cells 18 and then flows outside of the casing 10 through the first air holes 48, the second air holes 50, the third air holes 52, and the drain holes 54. In contrast, a case where air flows out from within the casing 10 through the cooling opening 30 by the operation of the built-in fan of the charger 4 when the battery pack 2 is attached to the charger 4 for charging will be considered. In this case, air flows into the casing 10 through the first air holes 48, the second air holes 50, the third air holes 52, and the drain holes 54. The air flowing into the casing 10 cools the plurality of battery cells 18 and then flows outside of the casing 10 through the cooling opening 30.

In the battery pack 2 of this embodiment, the first air holes 48 and the second air holes 50 are defined in the finger rest surface 44a and the front cylindrical surface 46a, which are positioned above the lower surface 10b of the casing 10. This allows for more balanced cooling of the battery cells 18 in the first tier from the bottom and the battery cells 18 in the second tier from the bottom compared to when the first air holes 48 and second air holes 50 are defined at lower positions.

In the battery pack 2 of this embodiment, the cell holder 20 has a shape that closes a part between the first air holes 48, the second air holes 50, the third air holes 52, the drain holes 54, and the plurality of battery cells 18. Therefore, even if an elongated foreign object such as a nail enters through the first air holes 48, the second air holes 50, the third air holes 52, or the drain holes 54, it is possible to suppress such foreign object from coming into contact with the battery cell(s) 18.

### Second Embodiment

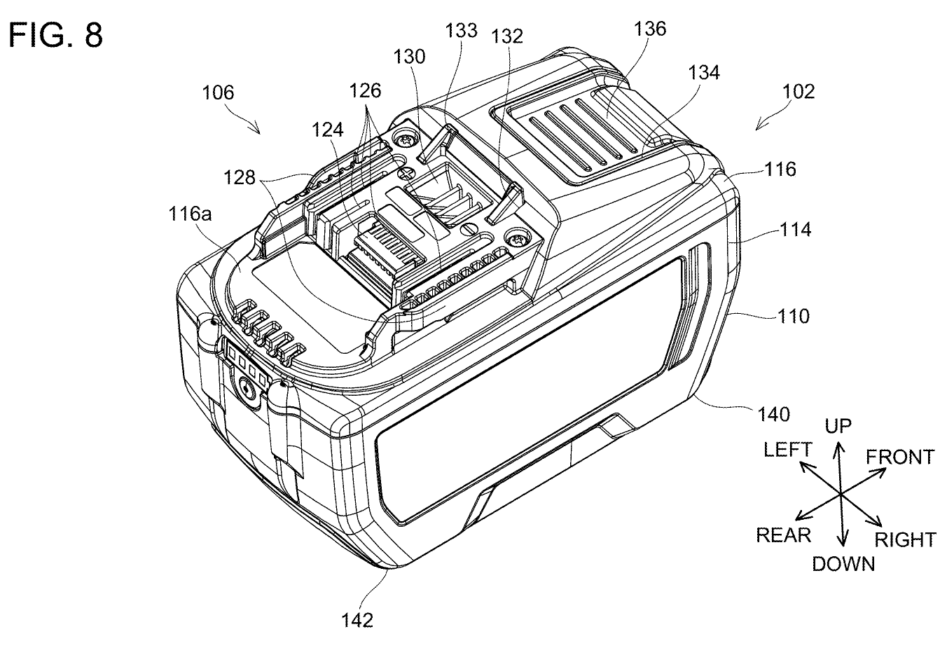

A battery pack 102 of the present embodiment, shown in FIG. 8, has a configuration substantially the same as the battery pack 2 according to the first embodiment. The battery pack 102 of the present embodiment can be detachably attached to electrical equipment (not shown). The electrical equipment operates on power supplied from the battery pack 102. The electrical equipment may be a motor-driven power tool such as a driver and a drill or may be a motor-driven power working machine such as a grass cutter and a blower. Alternatively, the electrical equipment may be equipment that does not have a motor, such as a light, radio, or a loudspeaker. The rated voltage of the battery pack 102 is, for example, 18V. The maximum voltage of the battery pack 102 is, for example, 20V. The rated capacity of the battery pack 102 is, for example, 12.0Ah.

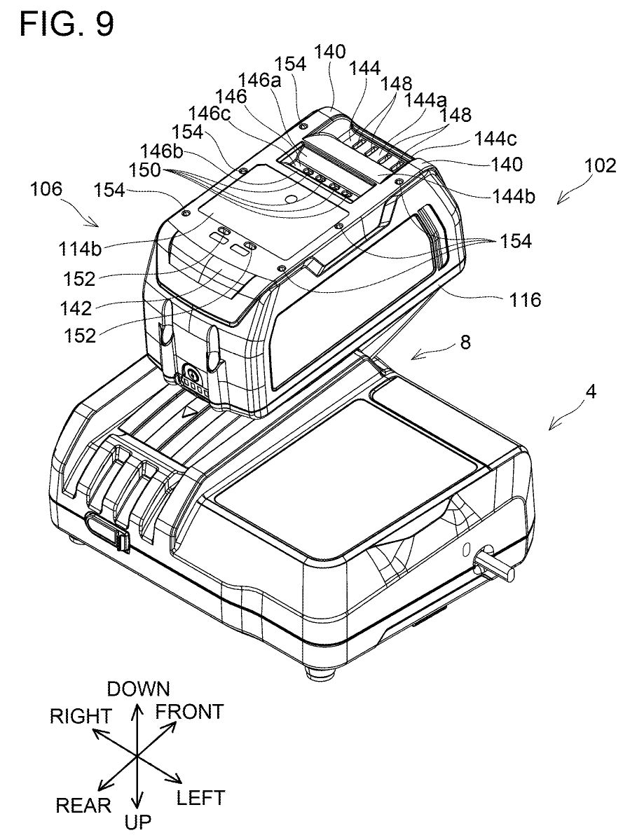

As illustrated in FIG. 9, the battery pack 102 can be detachably attached to the charger 4. The battery pack 102 is charged by power supplied from the charger 4. The battery pack 102 comprises an equipment attaching part 106. The charger 4 comprises a battery pack attaching part 8. The battery pack 102 can be attached to the charger 4 by sliding the equipment attaching part 106 in a predetermined sliding direction relative to the battery pack attaching part 8. Hereafter, a direction of sliding the battery pack 102 when the battery pack 102 is to be attached to the battery pack attaching part 8 will be termed a rear direction, whereas a direction of sliding the battery pack 102 when the battery pack 102 is to be detached from the battery pack attaching part 8 will be termed a front direction. Likewise, a direction in which the battery pack attaching part 8 is positioned when viewed from the battery pack 102 when the battery pack 102 is attached to the battery pack attaching part 8 will be termed an up direction whereas a direction opposite from the up direction will be termed a down direction. Further, a direction perpendicular to the front-rear direction and the up-down direction will be termed a left-right direction.

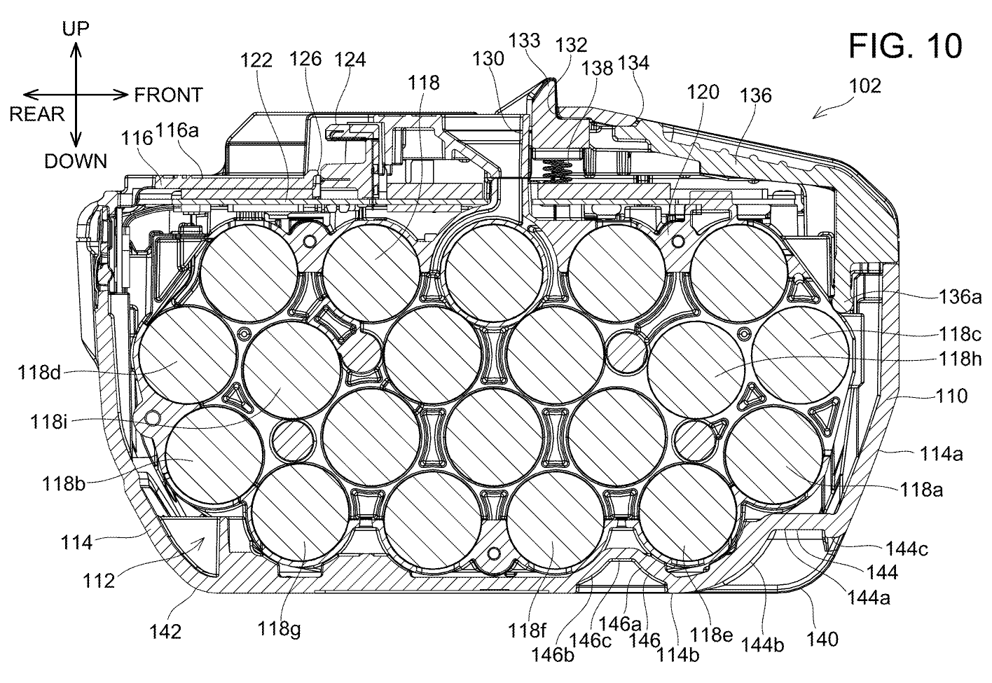

As illustrated in FIG. 10, the battery pack 102 comprises a casing 110 and a battery cell unit 112 housed within the casing 110. The casing 110 comprises a lower casing 114 and an upper casing 116. The up-down directional dimension of the battery pack 102 is, for example, within the range of 70 mm to 110 mm, and more specifically, for example, 92 mm. The front-rear directional dimension of the battery pack 102 is, for example, within the range of 135 mm to 175 mm, and more specifically, for example, 155 mm. The left-right directional dimension of the battery pack 102 is, for example, within the range of 55 mm to 95 mm, and more specifically, for example, 76 mm. The weight of the battery pack 102 is, for example, within the range of 0.9 kg to 1.7 kg, and more specifically, for example, 1.3 kg.

The battery cell unit 112 comprises a plurality of battery cells 118, a cell holder 120 configured to hold the plurality of battery cells 118, and a control circuit board 122 held by the cell holder 120 above the cell holder 120. A battery-side terminal 124 is disposed on the upper surface of the control circuit board 122.

The plurality of battery cells 118 is arranged in four tiers in the up-down direction. Each battery cell 118 is, for example, a lithium-ion battery cell. Alternatively, each battery cell 118 may be another type of secondary battery cell. Each battery cell 118 has a substantially cylindrical shape and is arranged with its longitudinal direction aligned along the left-right direction. The shape of each battery cell 118 is for example, a 18650 type, and has a diameter of 18 mm and a longitudinal dimension of 65 mm. Alternatively, the shape of each battery cell 118 is for example, a 21700 type and has a diameter of 21 mm and a longitudinal dimension of 70 mm. In the first tier from the bottom, four battery cells 118 are arranged side-by-side in the front-rear direction. Among the battery cells 118 in the first tier from the bottom, a battery cell 118e which is the first frontmost cell and a battery cell 118g which is the first rearmost cell are positioned slightly higher than the other battery cells 118. Among the battery cells 118 in the first tier from the bottom, the two battery cells 118 excluding the battery cell 118e which is the first frontmost cell and the battery cell 118g which is the first rearmost cell are all located lowermost among all of the plurality of battery cells 118. In the second tier from the bottom, five battery cells 118 are arranged side-by-side in the front-rear direction. In the front-rear direction, the position of the center of each battery cell 118 in the second tier from the bottom is arranged so as not to overlap the position of the center of each battery cell 118 in the first tier from the bottom. Among the battery cells 118 in the second tier from the bottom, a battery cell 118a which is the first frontmost cell and a battery cell 118b which is the first rearmost cell are positioned slightly lower than the other battery cells 118. In the third tier from the bottom, six battery cells 118 are arranged side-by-side in the front-rear direction. In the front-rear direction, the center position of each battery cell 118 in the third tier from the bottom is arranged so as not to overlap the center position of each battery cell 118 in the second tier from the bottom. Among the battery cells 118 in the third tier from the bottom, a battery cell 118h which is the second frontmost cell and a battery cell 118i which is the second rearmost cell are positioned slightly lower than the other battery cells 118. Among the battery cells 118 in the third tier from the bottom, a battery cell 118c which is the first frontmost cell is positioned frontmost among the plurality of battery cells 118, and a battery cell 118d which is the first rearmost cell is positioned rearmost among the plurality of battery cells 118. In the fourth tier from the bottom, i.e., the first tier from the top, five battery cells 118 are arranged side-by-side in the front-rear direction. In the front-rear direction, the center position of each battery cell 118 in the fourth tier from the bottom is arranged so as not to overlap the center position of each battery cell 118 in the third tier from the bottom. The battery cells 118 in the fourth tier from the bottom are arranged such that their positions in the up-down direction are substantially the same.

As illustrated in FIG. 8, the upper surface 116a of the upper casing 116 comprises a terminal opening 126, battery-side rails 128, a cooling opening 130, an engagement opening 132, and an operation opening 134. The terminal opening 126 is positioned at a position corresponding to the battery-side terminal 124 of the control circuit board 122. When attaching the battery pack 102 to electrical equipment or the charger 4, the battery-side terminal 124 of the battery pack 102 and the equipment-side terminal (not shown) of the electrical equipment or the charger 4 mechanically engage and electrically connect with each other via the terminal opening 126. The battery-side rails 128 extend in the front-rear direction to the left and right of the terminal opening 126. When attaching the battery pack 102 to electrical equipment or the charger 4, the battery-side rails 128 of the battery pack 102 slidably engage with equipment-side rails (not shown) of the electrical equipment or the charger 4 in the front-rear direction. The cooling opening 130 is positioned frontward of the terminal opening 126. When attaching the battery pack 102 to the charger 4 for charging, cooling air flows into the casing 110 through the cooling opening 130 by operation of a fan (not shown) built in the charger 4. In contrast, when attaching the battery pack 102 to the charger 4 for charging, cooling air may also flow out from within the casing 110 through the cooling opening 130 by the operation of the built-in fan of the charger 4. The engagement opening 132 is positioned frontward of the cooling opening 130. An engagement member 133 protruding outward from the engagement opening 132 is attached to the engagement opening 132. The operation opening 134 is positioned frontward of the engagement opening 132. An operation member 136 exposed outside through the operation opening 134 is attached to the operation opening 134. As illustrated in FIG. 10, the engagement member 133 is supported on the cell holder 120 via a compression spring 138. The compression spring 138 biases the engagement member 133 upward relative to the cell holder 120. The operation member 136 is supported by the upper casing 116 so as to be pivotable about a pivot axis 134a. The rear end (not shown) of the operation member 136 is inserted into a through hole (not shown) formed in the engagement member 133. When the user performs a push-in operation on the operation member 136, the operation member 136 pivots from its initial position to a pushed-in position. This causes the rear end of the operation member 136 to move downward, pushing the engagement member 133 downward against the biasing force of the compression spring 138. When the user releases the push-in operation on the operation member 136, the engagement member 133 moves upward due to the biasing force of the compression spring 138. This causes the rear end of the operation member 136 to move upward, by which the operation member 136 pivots from the pushed-in position to the initial position.

In a state where the battery pack 102 is attached to electrical equipment or the charger 4, the engagement member 133 engages with an engagement groove (not shown) of the electrical equipment or the charger 4, by which the battery pack 102 is prohibited from sliding frontward. This prevents the battery pack 102 from being detached from the electrical equipment or the charger 4. When detaching the battery pack 102 from the electrical equipment or the charger 4, the user performs a push-in operation on the operation member 136. This operation allows the engagement member 133 to disengage from the engagement groove of the electrical equipment or the charger 4, permitting the battery pack 102 to slide frontward relative to the electrical equipment or the charger 4. By sliding the battery pack 102 frontward from this state, the user can detach the battery pack 102 from the electrical equipment or the charger 4.

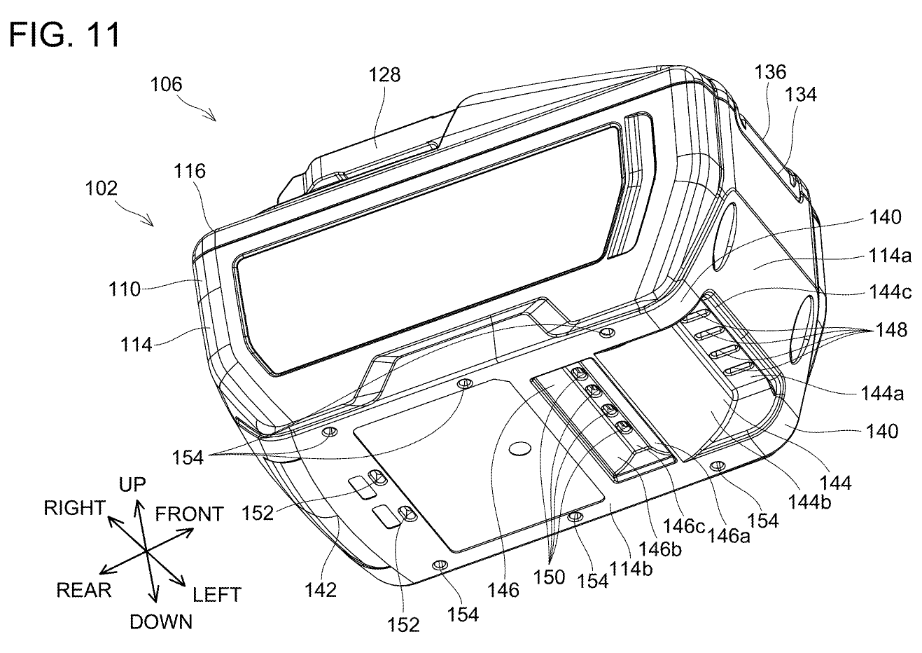

As illustrated in FIG. 11, front guard portions 140 protruding frontward and downward are arranged at a front lower right end and a front lower left end of the lower casing 114. A rear guard portion 142 protruding rearward and downward is arranged at a rear lower end of the lower casing 114. If the battery pack 102 accidentally falls, the front guard portions 140 or rear guard portion 142 will collide with the ground or floor surface. As illustrated in FIG. 10, within the casing 110, each battery cell 118 is positioned away from the front guard portions 140 and rear guard portion 142. Therefore, even if the front guard portions 140 or rear guard portion 142 collide with the ground or floor surface, damage to each battery cell 118 can be suppressed.

As illustrated in FIG. 11, the lower casing 114 comprises a first finger rest recess 144 and a second finger rest recess 146. The first finger rest recess 144 is positioned inward of the front guard portions 140 in the left-right direction, extending across a front surface 114a of the lower casing 114 and a lower surface 114b of the lower casing 114. The front-rear directional dimension of the first finger rest recess 144 is, for example, within the range of 10 mm to 50 mm, and more specifically, for example, 30 mm. The left-right directional dimension of the first finger rest recess 144 is, for example, within the range of 40 mm to 80 mm, and more specifically, for example, 48 mm. The second finger rest recess 146 is positioned rearward of the first finger rest recess 144 on the lower surface 114b of the lower casing 114. The front-rear directional dimension of the second finger rest recess 146 is, for example, within the range of 5 mm to 30 mm, and more specifically, for example, 17 mm. The left-right directional dimension of the second finger rest recess 146 is, for example, within the range of 40 mm to 80 mm, and more specifically, for example, 48 mm. The left-right directional width of the first finger rest recess 144 and the left-right directional width of the second finger rest recess 146 are substantially the same.

As illustrated in FIG. 10, the first finger rest recess 144 is positioned close to the first battery cell 118e which is the first frontmost cell among the battery cells 118 in the first tier from the bottom and also close to the first battery cell 118a which is the first frontmost cell among the battery cells 118 in the second tier from the bottom. The first finger rest recess 144 comprises: a substantially flat finger rest surface 144a disposed along the front-rear and left-right directions and facing downward; a cylindrical surface 144b having a substantially cylindrical shape, which is disposed rearward and downward relative to the finger rest surface 144a and conforms to the outer shape of the front lower portion of the battery cell 118e; and a slip-resistant portion 144c protruding downward from the front end of the finger rest surface 144a and extending in the left-right direction. The up-down directional distance from the lower surface 114b of the lower casing 114 to the finger rest surface 144a is, for example, within the range of 5 mm to 25 mm, and more specifically, for example, 12 mm. The front-rear directional dimension of the finger rest surface 144a is within the range of, for example, 2 mm to 15 mm, and more specifically, for example, 9 mm. In the up-down direction, the finger rest surface 144a is positioned above the lower end of the battery cell 118e, below the center of the battery cell 118e, below the upper end of the battery cell 118e, and below the lower end of the battery cell 118a. In the front-rear direction, the rear end of the finger rest surface 144a is positioned rearward of the front end of the battery cell 118a, rearward of the center of the battery cell 118a, frontward of the rear end of the battery cell 118a, and frontward of the front end of the battery cell 118e. That is, the first finger rest recess 144 is located in the space positioned in front of the battery cell 118e and below battery cell 118a. In the up-down direction, the finger rest surface 144a is positioned above the lower end of a battery cell 118f which is the second frontmost cell among the battery cells 118 in the first tier from the bottom, below the center of the battery cell 118f, and below the upper end of the battery cell 118f. In the front-rear direction, the front end of the finger rest surface 144a is positioned rearward of the front end of the battery cell 118c which is the first frontmost cell among the battery cells 118 in the third tier from the bottom and frontward of the center of this battery cell 118c. In the front-rear direction, the rear end of the finger rest surface 144a is positioned rearward of the center of the battery cell 118c and frontward of the rear end of the battery cell 118c.

The second finger rest recess 146 is positioned close to the battery cell 118e which is the first frontmost cell and the second battery cell 118f which is the second frontmost cell among the battery cells 118 in the first tier from the bottom. The second finger rest recess 146 comprises a front cylindrical surface 146a having a substantially cylindrical surface shape conforming to the outer shape of the rear lower portion of the battery cell 118e, a rear cylindrical surface 146b having a substantially cylindrical surface shape conforming to the outer shape of the front lower portion of the battery cell 118f, and a connecting surface 146c having a substantially planar shape, connecting the rear end of the front cylindrical surface 146a and the front end of the rear cylindrical surface 146b, disposed along the front-rear and left-right directions and facing downward. The up-down directional distance from the lower surface 114b of the lower casing 114 to the connecting surface 146c is, for example, within the range of 5 mm to 25 mm, and more specifically, for example, 6 mm. The front-rear directional dimension of the connecting surface 146c is, for example, within the range of 2 mm to 15 mm, and more specifically, for example, 4 mm. In the up-down direction, the connecting surface 146c is positioned above the lower end of the battery cell 118f, above the lower end of the battery cell 118e, below the center of the battery cell 118f, and below the center of the battery cell 118e. In the front-rear direction, the front end of the connecting surface 146c is positioned rearward of the rear end of the battery cell 118e and frontward of the front end of the battery cell 118f. In the front-rear direction, the rear end of the connecting surface 146c is positioned rearward of the rear end of the battery cell 118e and frontward of the front end of the battery cell 118f.

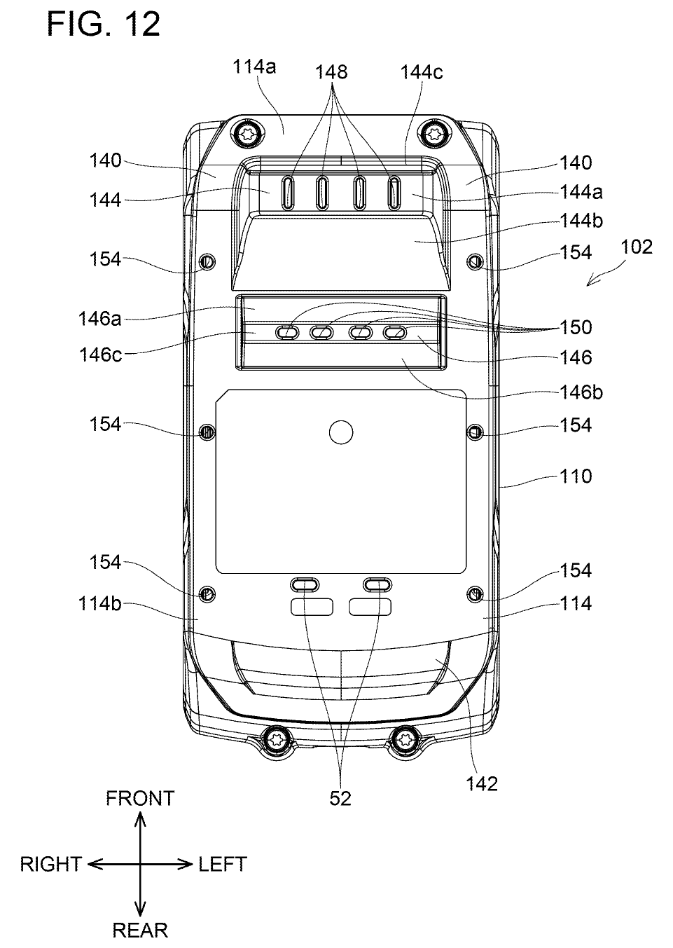

As illustrated in FIG. 12, the lower casing 114 comprises four first air holes 148, four second air holes 150, two third air holes 152, and six drain holes 154. The first air holes 148 have an elongated hole shape with a longitudinal direction extending in the front-rear direction and are arranged side-by-side in the left-right direction on the finger rest surface 144a of the first finger rest recess 144. The front-rear directional dimension of each first air hole 148 is, for example, within the range of 1 mm to 15 mm, and more specifically, for example, 8 mm. The left-right directional dimension of each first air hole 148 is, for example, within the range of 1 mm to 4 mm, and more specifically, for example, 3 mm. The second air holes 150 have an elongated hole shape with a longitudinal direction extending in the left-right direction and are arranged side-by-side in the left-right direction on the connecting surface 146c of the second finger rest recess 146. The front-rear directional dimension of each second air hole 150 is, for example, within the range of 1 mm to 4 mm, and more specifically, for example, 3 mm. The left-right directional dimension of each second air hole 150 is, for example, within the range of 1 mm to 10 mm, and more specifically, for example, 5.5 mm. The third air holes 152 have an elongated hole shape with a longitudinal direction extending in the left-right direction and are arranged side-by-side in the left-right direction near the rear end of the lower surface 114b of the lower casing 114. The front-rear directional dimension of each third air hole 152 is, for example, within the range of 1 mm to 4 mm, and more specifically, for example, 3.5 mm. The left-right directional dimension of each third air hole 152 is within the range of, for example, 1 mm to 10 mm, and more specifically, for example, 7 mm. The drain holes 154 have a circular hole shape and are arranged side-by-side in the front-rear direction near the right end and left end of the lower surface 114b of the lower casing 114. The diameter of each drain hole 154 is within the range of, for example, 1 mm to 4 mm, and more specifically, for example, 3 mm. In the left-right direction, the first air holes 148, the second air holes 150, and the third air holes 152 are positioned inward of the drain holes 154.

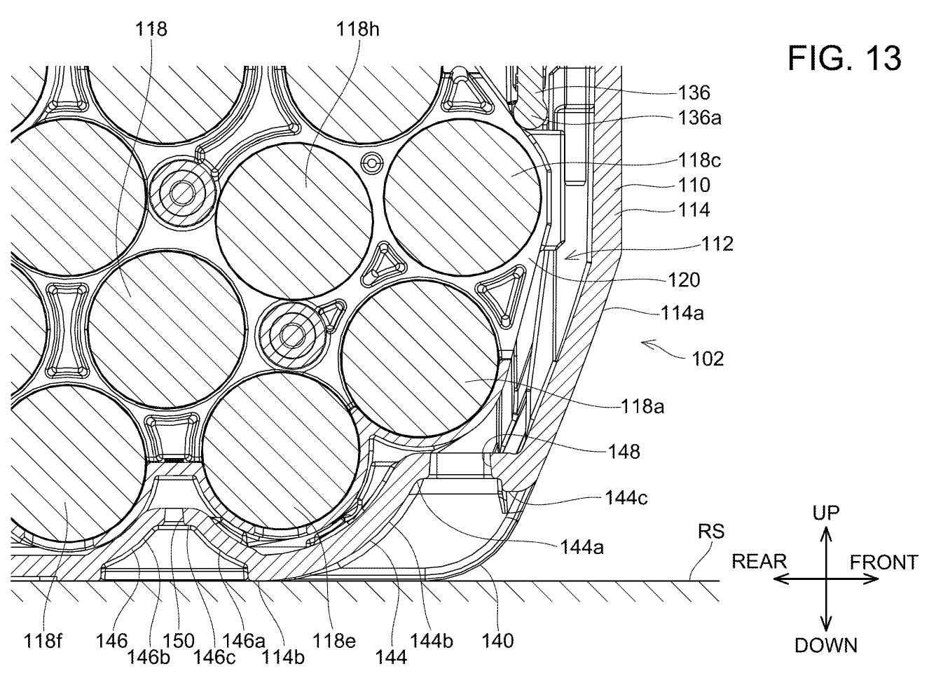

As illustrated in FIG. 13, in the up-down direction, the inner surface of the lower casing 114 at the location where the first air holes 148 are positioned (i.e., the finger rest surface 144a) is positioned above the lower end of the battery cell 118f, which is located lowermost among the plurality of battery cells 118, is positioned above the center of the battery cell 118f, and positioned below the upper end of the battery cell 118f. In the front-rear direction, the front ends of the first air holes 148 are positioned rearward of the front end of the battery cell 118c, which is located frontmost among the plurality of battery cells 118, are positioned frontward of the center of the battery cell 118c, and are positioned frontward of the rear end of the battery cell 118c. In the front-rear direction, the rear ends of the first air holes 148 are positioned rearward of the front end of the battery cell 118c which is located frontmost among the plurality of battery cells 118, are positioned rearward of the center of the battery cell 118c, and are positioned frontward of the rear end of the battery cell 118c. When the battery pack 102 is placed on the resting surface RS such that the lower surface 114b of the lower casing 114 contacts the resting surface RS, the first air holes 148 communicate with the space positioned frontward of the battery pack 102.

In the up-down direction, the inner surface of the lower casing 114 at the location where the second air holes 150 are positioned (i.e., the connecting surface 146c) is positioned above the lower end of the battery cell 118f, above the lower end of the battery cell 118e, positioned below the center of the battery cell 118f, and below the center of the battery cell 118e. In the front-rear direction, the front ends of the second air holes 150 are positioned rearward of the rear end of the battery cell 118e and frontward of the front end of the battery cell 118f. In the front-rear direction, the rear ends of the second air holes 150 are positioned rearward of the rear end of the battery cell 118e and frontward of the front end of the battery cell 118f. When the battery pack 102 is placed on the resting surface RS such that the lower surface 114b of the lower casing 114 contacts the resting surface RS, the second air holes 150 do not communicate with the space positioned frontward, rearward, leftward, or rightward of the battery pack 102.

As illustrated in FIG. 12, the third air holes 152 and the drain holes 154 are both defined in the lower surface 114b of the lower casing 114, and are therefore positioned below the first air holes 148 and the second air holes 150. Therefore, if water enters the interior of the casing 110, positioning the battery pack 102 such that the lower surface 114b of the lower casing 114 faces vertically downward allows the water inside the casing 110 to be discharged outside of the casing 110 through the third air holes 152 and the drain holes 154.

As illustrated in FIG. 9, a case where air flows into the casing 110 through the cooling opening 130 by operation of a built-in fan of the charger 4 when the battery pack 102 is attached to the charger 4 for charging will be considered. In this case, the air flowing into the casing 110 through the cooling opening 130 cools the plurality of battery cells 118 and then flows outside of the casing 110 through the first air holes 148, the second air holes 150, the third air holes 152, and the drain holes 154. In contrast, a case where air flows out from within the casing 110 through the cooling opening 130 by the operation of the built-in fan of the charger 4 when the battery pack 102 is attached to the charger 4 for charging will be considered. In this case, air flows into the casing 110 through the first air holes 148, the second air holes 150, the third air holes 152, and the drain holes 154. The air flowing into the casing 110 cools the plurality of battery cells 118 and then flows outside of the casing 110 through the cooling opening 130.

In the battery pack 102 of this embodiment, the first air holes 148 and the second air holes 150 are defined in the finger rest surface 144a and the connecting surface 146c, which are positioned above the lower surface 110b of the casing 110. This allows for more balanced cooling of the battery cells 118 in the first tier from the bottom and the battery cells 118 in the second tier from the bottom compared to when the first air holes 148 and second air holes 150 are defined at lower positions.

In the battery pack 102 of this embodiment, the cell holder 120 has a shape that closes a part between the first air holes 148, the second air holes 150, the third air holes 152, the drain holes 154, and the plurality of battery cells 118. Therefore, even if an elongated foreign object such as a nail enters through the first air holes 148, the second air holes 150, the third air holes 152, or the drain holes 154, it is possible to suppress such foreign object from coming into contact with the battery cell(s) 118.

### Modifications

In each of the above embodiments, the plurality of battery cells 18, 118 may not be cylindrical but they may be, for example, prismatic or pouch-type.

In each of the above embodiments, the plurality of battery cells 18, 118 may be arranged such that their longitudinal direction aligns with the front-rear direction.

In each of the above embodiments, the plurality of battery cells 18, 118 may be arranged in one or two tiers in the up-down direction.

In each of the above embodiments, the first air holes 48, 148 may have an elongated hole shape with their longitudinal direction extending in the left-right direction, or they may have a circular hole shape. The second air holes 50, 150 may have an elongated hole shape with their longitudinal direction extending in the front-rear direction, or they may have a circular hole shape.

### Features of Embodiments

Given the above, the battery pack 2, 102 in one or more embodiments is configured to be detachably attached to the battery pack attaching part 8 by sliding relative to the battery pack attaching part 8. The battery pack 2, 102 comprises: the casing 10, 110; and the plurality of battery cells 18, 118 accommodated inside the casing 10, 110. The front direction is defined as a direction of sliding the battery pack 2, 102 when detaching the battery pack 2, 102 from the battery pack attaching part 8. The rear direction is defined as a direction of sliding the battery pack 2, 102 when attaching the battery pack 2, 102 to the battery pack attaching part 8. The up direction is defined as a direction in which the battery pack attaching part 8 is positioned as viewed from the battery pack 2, 102 when the battery pack 2, 102 is attached to the battery pack attaching part 8. The down direction is defined as a direction opposite the up direction. The left-right direction is defined as a direction perpendicular to a front-rear direction and an up-down direction. The first through holes 48, 148 and the second through holes 50, 150 (examples of through hole) which open downward are defined in the casing 10, 110. In the front-rear direction, the first through holes 48, 148 and the second through holes 50, 150 are disposed rearward of the front end of the frontmost battery cell 18c, 118c among the plurality of battery cells 18, 118 and frontward of the rear end of the rearmost battery cell 18d, 118d among the plurality of battery cells 18, 118. In the up-down direction, the inner surface of the casing 10, 110 at the portion where the first through holes 48, 148 and the second through holes 50, 150 are defined is disposed above the lower end of the lowermost battery cell 18f, 118f among the plurality of battery cells 18, 118.

According to the above configuration, when the fan incorporated in the charger 4 is driven such that air is drawn out from within the casing 10, 110 toward the charger 4, the air flows in through the first through holes 48, 148 and the second through holes 50, 150 that are disposed rearward of the front end of the frontmost battery cell 18c, 118c and frontward of the rear end of the rearmost battery cell 18d, 118d and also opened downward, as a result of which accumulation of heat near the lower surface 14b, 114b of the casing 10, 110 can be suppressed. This configuration can suppress the battery cell(s) 18, 118 near the lower surface 14b, 114b of the casing 10, 110 from becoming excessively hot. Further, in the above configuration, the inner surface of the casing 10, 110 at the position where the first through holes 48, 148 and the second through holes 50, 150 are defined is above the lower surface of the lowermost battery cell 18f, 118f. Due to this, when the battery pack 2, 102 is placed on the resting surface RS such that the lower surface 14b, 114b of the casing 10, 110 contacts the resting surface RS, it is possible to more effectively suppress water and/or mud on the resting surface RS from adhering to the first through holes 48, 148 and the second through holes 50, 150 and thereby blocking the first through holes 48, 148 and the second through holes 50, 150.

In the battery pack 2, 102 in one or more embodiments, the plurality of battery cells 18, 118 comprises: the first battery cell 18e, 118e (example of a first battery cell) having a longitudinal direction extending in the left-right direction; and the battery cell 18f, 118f (example of a second battery cell) having a longitudinal direction extending in the left-right direction and disposed adjacent to and rearward of the battery cell 18e, 118e. In the front-rear direction, the second air holes 50, 150 are disposed rearward of the center of the battery cell 18e, 118e and frontward of the center of the battery cell 18f, 118f.

According to the above configuration, the battery cell 18e, 118e and the battery cell 18f, 118f that are adjacent to each other in the front-rear direction can be cooled in a well-balanced manner.

In the battery pack 2, 102 in one or more embodiments, the second air holes 50, 150 have an elongated hole shape having its longitudinal direction extending in the left-right direction.

According to the above configuration, the battery cell 18e, 118e and the battery cell 18f, 118f can be more uniformly cooled in the left-right direction.

In the battery pack 2, 102 in one or more embodiments, the first finger rest recess 44, 144 and the second finger rest recess 46, 146 (examples of a recess) are defined in the lower surface 14b, 114b of the casing 10, 110. The first finger rest recess 44, 144 and the second finger rest recess 46, 146 are recessed upward and extend in the left-right direction. The first air holes 48,148 and the second air holes 50, 150 are disposed in the first finger rest recess 44, 144 and the second finger rest recess 46, 146.

According to the above configuration, the first air holes 48, 148 and the second air holes 50, 150 can be provided in the casing 10, 110 by utilizing the first finger rest recess 44, 144 and the second finger rest recess 46, 146 that were formed for the purpose of finger rests for a user to grasp the battery pack 2, 102.

In the battery pack 2, 102 in one or more embodiments, the second air holes 50, 150 have an elongated hole shape having its longitudinal direction extending in the left-right direction.

According to the above configuration, when the user utilizes the second finger rest recess 46, 146 as a finger groove for grasping the battery pack 2, 102, the second air holes 50, 150 can function as a non-slip feature for the finger.

In the battery pack 2, 102 in one or more embodiments, when the battery pack 2, 102 is placed on the resting surface RS such that the lower surface 14b, 114b of the casing 10, 110 contacts the resting surface RS, the first air holes 48, 148 communicate with the space positioned frontward, rearward, leftward, or rightward of the battery pack 2, 102.

According to the above configuration, when the plurality of battery cells 18, 118 is in a high-temperature state and the battery pack 2, 102 is placed on the resting surface RS such that the lower surface 14b, 114b of the casing 10, 110 contacts the resting surface RS, air can flow from the outside into the casing 10, 110 through the first air holes 48, 148 due to chimney effect, by which the plurality of battery cells 18, 118 can be cooled.

In the battery pack 2, 102 in one or more embodiments, in the up-down direction, the inner surface of the casing 10, 110 at the portion where the first air holes 48, 148 are defined is disposed above the center of the lowermost battery cell 18f, 118f among the plurality of battery cells 18, 118.

According to the above configuration, when the battery pack 2, 102 is placed on the resting surface RS such that the lower surface 14b, 114b of the casing 10, 110 contacts the resting surface RS, it is possible to more effectively suppress water and/or mud on the resting surface RS from adhering to the first air holes 48, 148 and thereby blocking the first air holes 48, 148.

What is claimed is:

1. A battery pack configured to be detachably attached to a battery pack attaching part by sliding relative to the battery pack attaching part, the battery pack comprising:
a casing; and
a plurality of battery cells accommodated inside the casing,
wherein a front direction is defined as a direction of sliding the battery pack when detaching the battery pack from the battery pack attaching part,
a rear direction is defined as a direction of sliding the battery pack when attaching the battery pack to the battery pack attaching part,
an up direction is defined as a direction in which the battery pack attaching part is positioned as viewed from the battery pack when the battery pack is attached to the battery pack attaching part,
a down direction is defined as a direction opposite the up direction,
a left-right direction is defined as a direction perpendicular to a front-rear direction and an up-down direction,
a through hole which opens downward is defined in the casing,
in the front-rear direction, the through hole is disposed rearward of a front end of a frontmost battery cell among the plurality of battery cells and frontward of a rear end of a rearmost battery cell among the plurality of battery cells, and
in the up-down direction, an inner surface of the casing at a portion where the through hole is defined is disposed above a lower end of a lowermost battery cell among the plurality of battery cells.

2. The battery pack according to claim 1, wherein the plurality of battery cells comprises:
a first battery cell having a longitudinal direction extending in the left-right direction; and
a second battery cell having a longitudinal direction extending in the left-right direction and disposed adjacent to and rearward of the first battery cell, and
in the front-rear direction, the through hole is disposed rearward of a center of the first battery cell and frontward of a center of the second battery cell.

3. The battery pack according to claim 2, wherein the through hole has an elongated hole shape having a longitudinal direction extending in the left-right direction.

4. The battery pack according to claim 1, wherein a recess is defined in a lower surface of the casing, the recess recessed upward and extending in the left-right direction, and
the through hole is disposed in the recess.

5. The battery pack according to claim 4, wherein the through hole has an elongated hole shape having a longitudinal direction extending in the left-right direction.

6. The battery pack according to claim 1, wherein when the battery pack is placed on a resting surface such that a lower surface of the casing contacts the resting surface, the through hole communicates with a space positioned frontward, rearward, leftward, or rightward of the battery pack.

7. The battery pack according to claim 1, wherein, in the up-down direction, the inner surface of the casing at the portion where the through hole is defined is disposed above a center of the lowermost battery cell among the plurality of battery cells.

8. The battery pack according to claim 1, wherein the through hole comprises a first through hole and the second through hole,
the plurality of battery cells comprises:
a first battery cell having a longitudinal direction extending in the left-right direction; and
a second battery cell having a longitudinal direction extending in the left-right direction and disposed adjacent to and rearward of the first battery cell,
in the front-rear direction, the second through hole is disposed rearward of a center of the first battery cell and frontward of a center of the second battery cell,
the second through hole has an elongated hole shape having a longitudinal direction extending in the left-right direction,
a first recess and a second recess are defined in a lower surface of the casing, the first recess and the second recess being recessed upward and extending in the left-right direction,
the first through hole is disposed in the first recess,
the second through hole is disposed in the second recess,
when the battery pack is placed on a resting surface such that a lower surface of the casing contacts the resting surface, the first through hole communicates with a space positioned frontward, rearward, leftward, or rightward of the battery pack, and
in the up-down direction, the inner surface of the casing at the portion where the first through hole is defined is disposed above a center of the lowermost battery cell among the plurality of battery cells.
